(19) United States
(12) Patent Application Publication
(10) Pub. No.: US 2020/0005182 A1
(43) Pub. Date: Jan. 2, 2020

(54) SELECTION METHOD, SELECTION APPARATUS, AND RECORDING MEDIUM

(71) Applicant: FUJITSU LIMITED, Kawasaki-shi (JP)

(72) Inventor: Yuji Mizobuchi, Kawasaki (JP)

(73) Assignee: FUJITSU LIMITED, Kawasaki-shi (JP)

(21) Appl. No.: 16/430,699

(22) Filed: Jun. 4, 2019

(30) Foreign Application Priority Data
Jun. 27, 2018 (JP) 2018-122476

(51) Int. Cl. G06N 20/00; G06F 16/93

(52) U.S. Cl. CPC G06N 20/00; G06F 16/93

(57) ABSTRACT

A selection method executed by a processor included in a selection apparatus, the selection method includes when plurality of pieces of data are each determined as one of multiple determination candidates by using a learning model, calculating, for each of the plurality of pieces of data, a deviation index indicating a degree of uncertainty of a determination result obtained by using the learning model with respect to each of the multiple determination candidates; and when the learning model is updated, responsively selecting a particular unit of data targeted for redetermination to be performed by using the updated learning model from the plurality of pieces of data in accordance with the deviation index.

### CROSS-REFERENCE TO RELATED APPLICATION

This application is based upon and claims the benefit of priority of the prior Japanese Patent Application No. 2018-122476, filed on Jun. 27, 2018, the entire contents of which are incorporated herein by reference.

### FIELD

The embodiments discussed herein are related to a selection method, a selection apparatus, and a recording medium.

### BACKGROUND

A machine learning model is generated by training a learner to classify data into multiple classes by using training data. One example of a learning model is generated by learning determination of similarity between documents by using a large amount of data of documents and labels for indicating whether there is a similarity between documents. By inputting units of data of two documents targeted for determination into the model after learning, it is determined whether the two documents are similar to each other. Another example of a learning model is generated by learning prediction of cancer development by using a large amount of data of previous diagnostic cases and labels for indicating whether a patient of a given case of the diagnostic cases has developed a cancer. By inputting diagnostic data about a new patient into the model after learning, the risk of cancer development of the new patient is determined. Still another example of a learning model is generated by learning correspondence between failure phenomena, such as a system failure, and their causes. By inputting data of a failure phenomenon having newly occurred into the model after learning, the cause of the failure is determined.

These learning models are usually updated after generated due to various factors with the aim of achieving higher accuracy of determination. Due to various factors that occur with the passage of time, such as accumulation of new training data, change in the property of the label, change in parameters obtained by learning, and development of new learning technologies, learning models are updated relatively frequently. In a recent known technology, the accuracy of determination results with respect to a predetermined number of units of determination target data is calculated, and in accordance with the calculated accuracy, it is determined whether to adjust the learning model. When the learning model is updated accordingly, a determination operation is performed again by using the updated learning model for all units of determination target data for which the determination operation has been previously performed by using the learning model before learning.

Examples of the related art are disclosed in International Publication Pamphlet No. WO2010/046972, and Japanese Laid-open Patent Publication Nos. 2011-22864 and 2014-191450.

### SUMMARY

According to an aspect of the embodiments, a selection method executed by a processor included in a selection apparatus, the selection method includes when plurality of pieces of data are each determined as one of multiple determination candidates by using a learning model, calculating, for each of the plurality of pieces of data, a deviation index indicating a degree of uncertainty of a determination result obtained by using the learning model with respect to each of the multiple determination candidates; and when the learning model is updated, responsively selecting a particular unit of data targeted for redetermination to be performed by using the updated learning model from the plurality of pieces of data in accordance with the deviation index.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 illustrates an overall example of a learning apparatus according to a first embodiment;

FIG. 2 is a functional block diagram illustrating a functional configuration of the learning apparatus according to the first embodiment;

FIG. 3 is an example of information stored in a learning data database (DB);

FIG. 4 is an example of information stored in a determination target data DB;

FIG. 5 is an example of information stored in a priority order DB;

FIG. 6 illustrates an example of a determination function;

FIG. 7 is a flowchart illustrating a process flow;

FIG. 8 illustrates a specific example of data;

FIG. 9 illustrates the degrees of duplication of grammatical units among documents as features;

FIG. 10 illustrates the content of input data as a learning target and an output result;

FIG. 11 illustrates a determination result about determination target data;

FIG. 12 illustrates a calculation example of a deviation index;

FIG. 13 illustrates a setting example of a priority order used when redetermination is performed;

FIG. 14 illustrates relationships between changes in parameters and a determination function;

FIGS. 15A to 15C illustrate relationships between the degree of adjustment of a learning model and the change of the determination result;

FIG. 16 illustrates a setting example of an end condition; and

FIG. 17 illustrates an example of a hardware configuration.

### DESCRIPTION OF EMBODIMENTS

The technologies described above, however, take relatively long time to perform redetermination processing after the learning model is updated due to the large scale of data, which has been increasing in recent years. This may result in a serious opportunity loss. For example, when similarities among n documents are calculated by using a learning model, the amount of calculation for performing redetermination processing corresponds to the square of n times. Similarly, when the processing of cancer prediction is performed for n cancer patients by using a learning model, the amount of calculation for performing redetermination processing corresponds to n times. As understood from these examples, the time taken to perform redetermination processing increases as the number of units of target data increases. In the example of the learning model for determining failures, if it takes long time to perform redetermination processing after the learning model is updated, informing operators of latest determination results is delayed, and as a result, the opportunity to appropriately deal with operations is lost and the impact of the failures expands.

Hereinafter, embodiments of a selection program, a selection method, and a selection apparatus disclosed in the present application are described in detail with reference to the drawings. It is noted that the embodiments are not intended to limit the present disclosure. Furthermore, the embodiments may be combined with each other as appropriate when there is no contradiction.

### First Embodiment

Overall Example

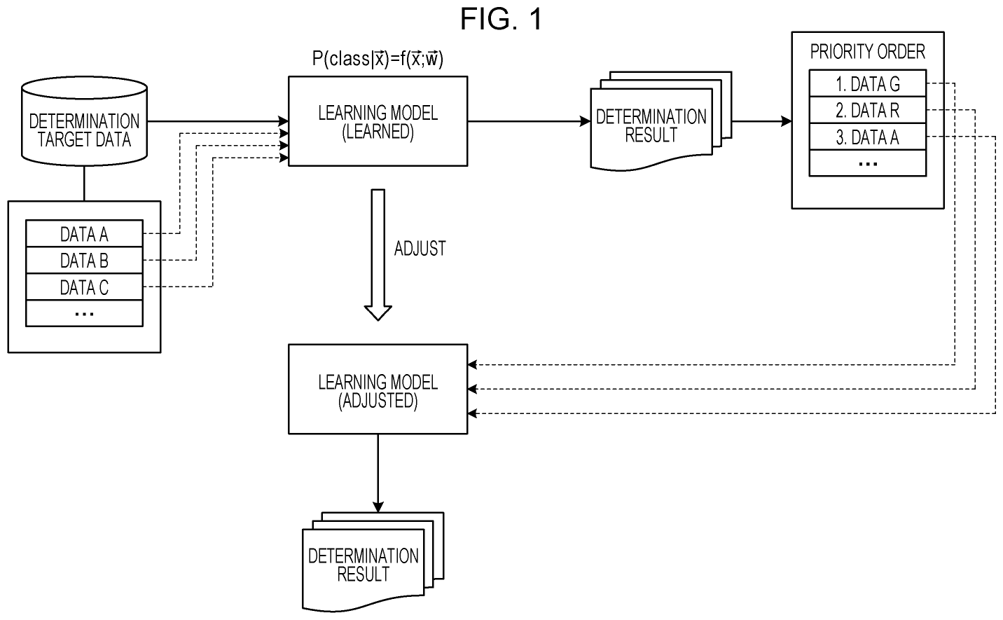

FIG. 1 illustrates an overall example of a learning apparatus according to a first embodiment. A learning apparatus 10 illustrated in FIG. 1 is an example of a selection apparatus that selects data to be targeted for determination after re-learning. For example, the learning apparatus 10 performs determination processing for plurality of pieces of determination target data by using a learning model trained by using training data and obtains determination results. The learning apparatus 10 specifies, in accordance with the determination result, particular units of determination target data about which the determination results are likely to change after the learning model is updated. After the learning model is updated, the learning apparatus 10 performs, by using the updated learning model, redetermination processing successively for a unit of determination target data about which it is determined that the corresponding determination result is most likely changed among the plurality of pieces of determination target data and consequently obtains new determination results.

For example, the learning apparatus 10 sequentially inputs data A, data B, and data C, which are all determination target data, into a learning model P, which outputs a determination result by using an input (x) and a weight (w), and consequently obtains a determination result. The learning apparatus 10 then calculates a deviation index with respect to each of the plurality of pieces of determination target data for which the determination processing has been performed by using the learning model. The deviation index indicates how much the determination result about a particular unit of determination target data deviates from a particular determination output candidate based on the learning model; in other words, the deviation index (also referred to as an uncertainty index) indicates the degree of uncertainty of a determination result obtained by using the learning model in regard to a particular unit of determination target data of the plurality of pieces of determination target data with respect to a particular determination candidate of multiple determination candidates and the deviation index is calculated when the plurality of pieces of determination target data are each determined whether to correspond to any one of the multiple determination candidates by using the learning model. In accordance with the deviation indexes, the learning apparatus 10 selects a sequential order starting with data G, followed by data R and data A as the order used in the redetermination processing. After the learning model is updated, the learning apparatus 10 sequentially inputs the data G, the data R, and the data A into the updated learning model and accordingly performs the redetermination processing.

In such a manner, the learning apparatus 10 is able to perform the determination processing by using the updated learning model with respect to plurality of pieces of data sequentially in order of possibility in which a particular unit of data is changed between before and after adjustment of the learning model, as a result, it is possible to practically reduce the time taken to perform the redetermination processing after the learning model is updated. It is noted that, although this embodiment is described by using an example in which the learning processing, the selection processing, the redetermination processing are all performed by the learning apparatus 10, these processing operations may be performed by separate apparatuses.

Functional Configuration

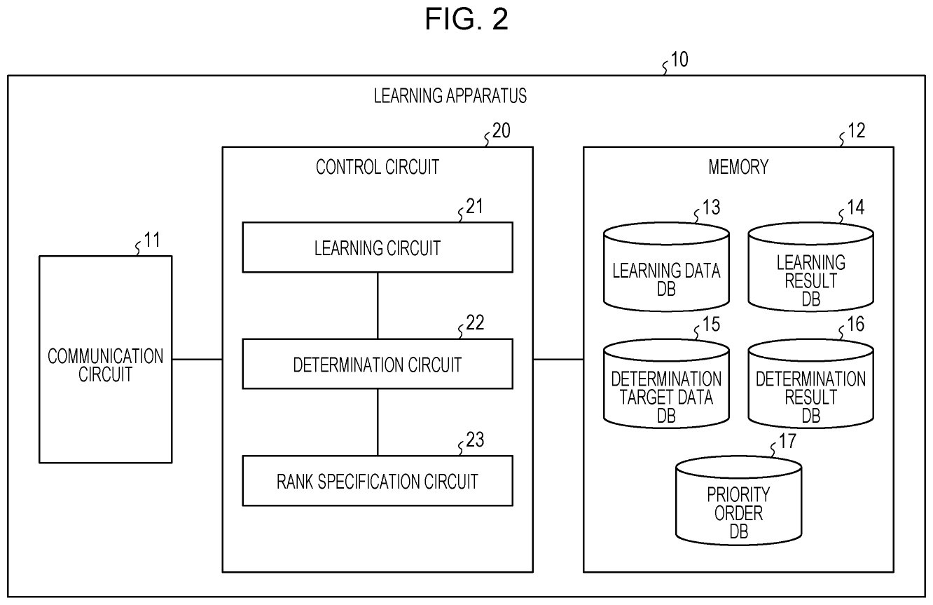

FIG. 2 is a functional block diagram illustrating a functional configuration of the learning apparatus 10 according to the first embodiment. As illustrated in FIG. 2, the learning apparatus 10 includes a communication circuit 11, memory 12, and a control circuit 20.

The communication circuit 11 is a processing circuit that controls communication with other devices and is, for example, a communication interface. For example, the communication circuit 11 receives an instruction for starting processing and learning data from an administrator terminal and transmits a determination result or the like to a selected terminal.

The memory 12 is an example of a storage device that stores programs and data and is, for example, a memory or a hard disk. The memory 12 stores a learning data DB 13, a learning result DB 14, a determination target data DB 15, a determination result DB 16, and a priority order DB 17.

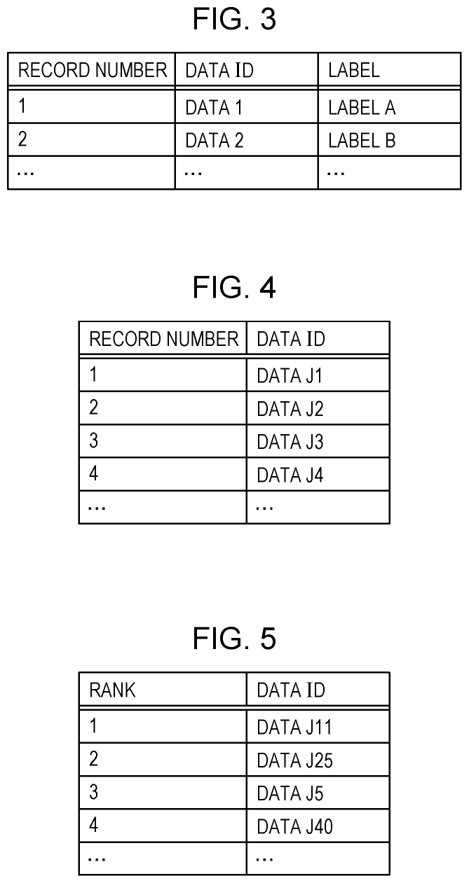

The learning data DB 13 stores learning data that is used for training a learning model. FIG. 3 is an example of information stored in the learning data DB 13. As illustrated in FIG. 3, the learning data DB 13 stores information of the record number, which is a number assigned to a particular unit of data, the data identifier (ID), which uniquely specifies a particular unit of data, and the label, which is assigned to data, in an associated manner. In the example in FIG. 3, label A is assigned to data 1 of record number 1 and label B is assigned to data 2 of record number 2. The learning data is not limited to supervised data (labeled data) but may be unsupervised data (unlabeled data) or both.

The learning result DB 14 stores learning results. The learning result DB 14 stores, for example, a determination result (a classification result) about learning data determined by the control circuit 20 and various parameters and various weights for a learner or a neural network that are learned by means of machine learning or deep learning.

The determination target data DB 15 stores determination target data targeted for the determination processing performed by using the learning model after learning. FIG. 4 is an example of information stored in the determination target data DB 15. As illustrated in FIG. 4, the determination target data DB 15 stores information of the record number, which is a number assigned to a particular unit of data, and the data identifier (ID), which uniquely specifies a particular unit of data, in an associated manner. In the example in FIG. 4, record number 1 of determination target is assigned to data 31 and record number 2 is assigned to data 32.

The determination result DB 16 stores determination results. For example, the determination result DB 16 stores determination results in association with corresponding units of determination target data stored in the determination target data DB 15.

The priority order DB 17 stores an order used in the redetermination processing after the learning model is updated. Specifically, the priority order DB 17 stores a priority order generated by a rank specification circuit 23 described later. FIG. 5 is an example of information stored in the priority order DB 17. As illustrated in FIG. 5, the priority order DB 17 stores information of the rank, which indicates a specified position of a unit of data in a priority order, and information of the data ID, which specifies a particular unit of data, in an associated manner. The example in FIG. 5 indicates the ranks used in the redetermination processing as follows: data J11, data J25, data J5, and data J40.

The control circuit 20 is a processing circuit that controls all processing operations performed by the learning apparatus 10 and is, for example, a processor. The control circuit 20 includes a learning circuit 21, a determination circuit 22, and a rank specification circuit 23. It is noted that the learning circuit 21, the determination circuit 22, and the rank specification circuit 23 are an example of processes executed by, for example, an electronic circuit included in a processor or a processor.

The learning circuit 21 is a processing circuit that performs learning processing of a learning model by using a set of learning data stored in the learning data DB 13 as input data. Specifically, the learning circuit 21 reads the data 1 from the learning data DB 13, inputs the data 1 into a learner, such as a neural network, and consequently obtains an output. The learning circuit 21 performs the learning processing so as to reduce the difference between the output value and label A.

In this manner, the learning circuit 21 trains or develops a learning model by performing learning processing so as to minimize, with respect to each unit of learning data, the difference between an output value output by a learner in regard to a particular unit of learning data and a preset label. After completing the learning processing, the learning circuit 21 stores, for example, various parameters in the learning result DB 14. It is noted that various kinds of neural networks, such as a recurrent neural network (RNN), may be used. Moreover, other than neural networks, various machine learning technologies, such as a support vector machine (SVM), a decision tree, and random forests, may be applied. Further, various learning methods, such as backpropagation, may be applied.

After a learning model is developed by performing the leaning processing, when there is a factor, for example, when a new set of learning data is accumulated, when the property of a label is changed, when the property of a parameter having been learned is changed, or when a new learning technology is developed, the learning circuit 21 adjusts the learning model by using a set of learning data stored in the learning data DB 13.

For example, the learning circuit 21 inputs new learning data into a learning model after learning and trains the learning model so as to reduce the difference between the output value and a particular label. In another example, the learning circuit 21 inputs the same learning data as that of the previous time into a learner to which a new technology is applied and trains the learner so as to reduce the difference between the output value and a particular label. After the re-learning processing is completed, the learning circuit 21 stores, for example, the parameters of the updated learning model in the learning result DB 14.

The determination circuit 22 is a processing circuit that performs determination for each unit of determination target data stored in the determination target data DB 15 by using the learning model that has been trained. For example, the determination circuit 22 reads various kinds of parameters from the learning result DB 14 and develops the learning model in which the various kinds of parameters are set. The determination circuit 22 subsequently reads units of determination target data from the determination target data DB 15, inputs the units of determination target data into the learning model, and accordingly obtains determination results. The determination circuit 22 then stores the determination results in the determination result DB 16, displays the determination results on a display, or transmits the determination results to an administrator terminal.

When the learning model is updated, the determination circuit 22 accordingly performs redetermination for the units of determination target data sequentially in an order stored in the priority order DB 17 by using the updated learning model. For example, in the example in FIG. 5, the determination circuit 22 performs redetermination firstly for data J11, secondly for data J25, and thirdly for data J5.

The rank specification circuit 23 is a processing circuit that determines a priority order of plurality of pieces of determination target data for which redetermination is to be performed after the learning model is updated. Specifically, the rank specification circuit 23 calculates, with respect to each of the plurality of pieces of determination target data stored in the determination target data DB 15, a deviation index, which indicates how much the determination result deviates from a particular determination output candidate based on the learning model before adjustment, and selects particular units of determination target data in accordance with the deviation indexes; in other words, the rank specification circuit 23 determines a priority order to perform redetermination while giving priority successively to a particular unit of determination target data about which the determination result is most likely changed among the determination results obtained in accordance with the learning model before adjustment.

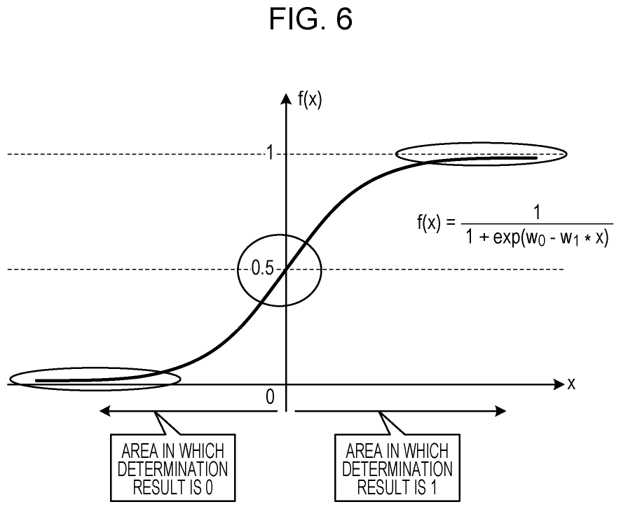

An example described here uses a sigmoid function as the function for determination. FIG. 6 illustrates an example of a determination function. As illustrated in FIG. 6, a sigmoid function f(x) is used for outputting a value in accordance with weights w₀ and w₁, which are obtained by learning, and an input x. The output value of the sigmoid function f(x) falls within the range of 1 to 0. In the area close to the output value 0, that is, the area in which the determination result is 0, or the area close to the output value 1, that is, the area in which the determination result is 1, the degree of deviation from an output candidate (an output value) is relatively small, and as a result, it is determined that the values in these areas are values with certainty. Conversely, in the area close to the output value 0.5, the degree of deviation from an output candidate (an output value) is relatively large, and as a result, it is determined that the values in this area are values with uncertainty.

In other words, in the area close to the output value 0 or 1, the degree of change in value after the learning model is updated is relatively small, and thus, it is determined that the possibility in which the determination result is changed is small. By contrast, in the area close to the output value 0.5 (the area close to the point where the input x is 0), the degree of change in value after the learning model is updated is relatively large, and thus, it is determined that the possibility in which the determination result is changed is large. Based on this concept, the rank specification circuit 23 selects determination target data whose determination result after adjustment of the learning model is likely changed in accordance with the determination result before adjustment.

Specifically, the rank specification circuit 23 calculates the degree of uncertainty that indicates how likely the determination result is changed due to adjustment of the learning model, and accordingly selects and ranks units of determination target data; in other words, the rank specification circuit 23 calculates a deviation index that indicates the degree at which an output candidate (a determination candidate) based on the learning model before adjustment is uncertain, that is, a deviation index that indicates deviation from an output candidate, and accordingly selects and ranks units of determination target data.

The rank specification circuit 23 calculates, for example, entropy of the determination result (the average amount of information) by using equation 1, and selects and ranks units of determination target data in accordance with the value of entropy. In another example, the rank specification circuit 23 may set in advance thresholds (an upper limit and a lower limit) for determining determination targets and select, as targets for redetermination, all units of determination target data whose probability value of the determination results based on the learning model before adjustment fall within the range between the thresholds. The thresholds may be determined in accordance with, for example, past actual information of distribution of plurality of pieces of data for which redetermination processing was desired.

H(P)=Σ_{AϵΩ}P(A)log(P(A)) equation 1

where A is an individual phenomenon and Ω is all phenomena.

Process Flow

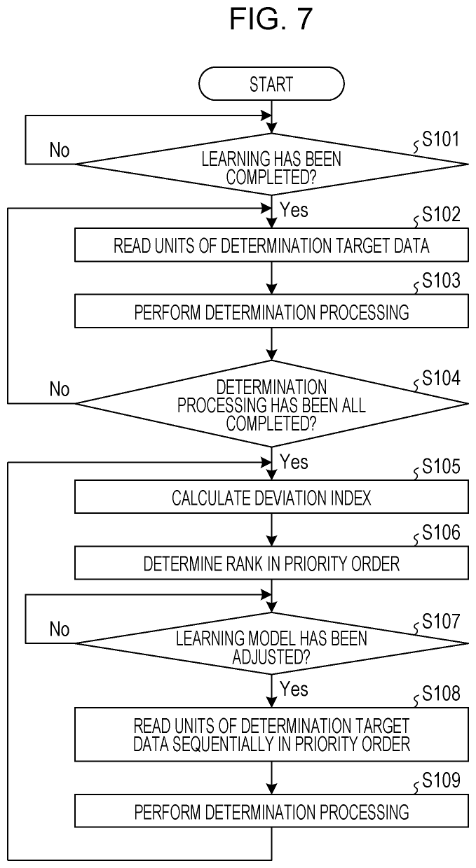

FIG. 7 is a flowchart illustrating a process flow. In the following description, the determination processing, the selection processing, the redetermination processing are performed in series as one process flow but may be performed separately.

As illustrated in FIG. 7, after learning has been completed by the learning circuit 21 (Yes in S101), the determination circuit 22 reads units of determination target data from the determination target data DB 15 (S102), performs the determination processing, and stores the determination result in the determination result DB 16 (S103).

When remaining determination target data still exists and it is thus determined that the determination processing has not been all completed (No in S104), the processing operations in S102 and the subsequent step are repeated for the remaining determination target data. By contrast, when no remaining determination target data exists and it is thus determined that the determination processing has been all completed (Yes in S104), the rank specification circuit 23 calculates a deviation index by using the determination result (S105).

The rank specification circuit 23 determines a rank in a priority order that is to be used in the redetermination processing with respect to each unit of determination target data in accordance with the corresponding deviation index and stores the determined rank in the priority order DB 17 (S106).

After the learning model is updated (Yes in S107), the determination circuit 22 reads the units of determination target data sequentially in the priority order stored in the priority order DB 17(5108), performs the redetermination processing for the units of determination target data, and stores the determination results in the determination result DB 16 (S109). Subsequently, the process returns to S105 and another priority order is determined for subsequent adjustment.

Specific Example

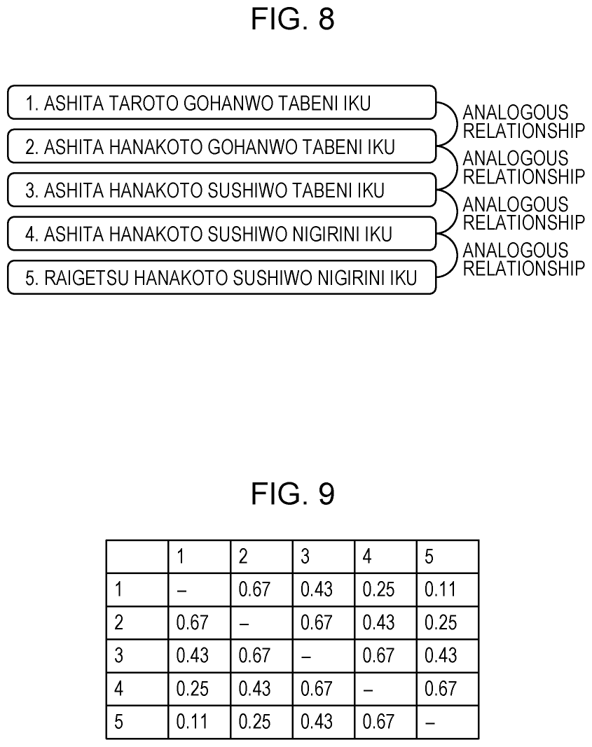

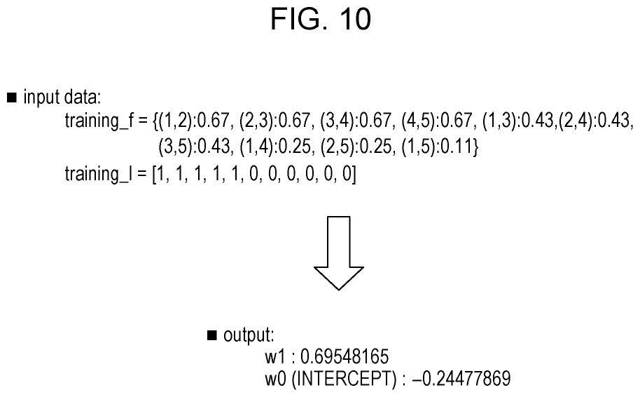

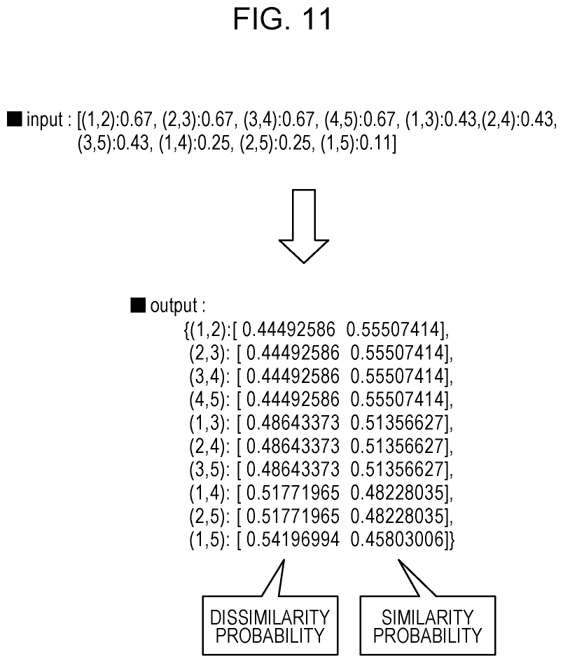

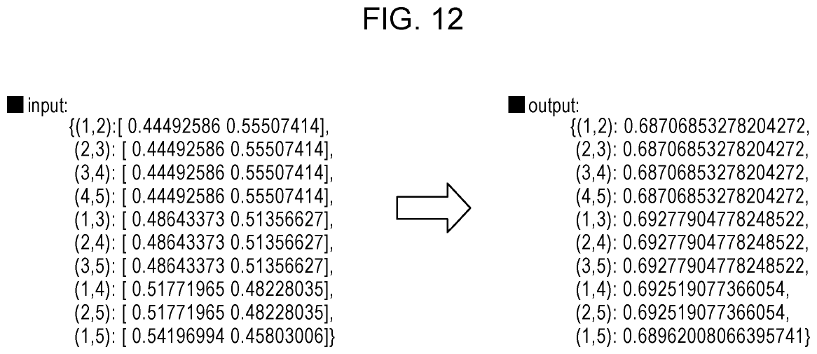

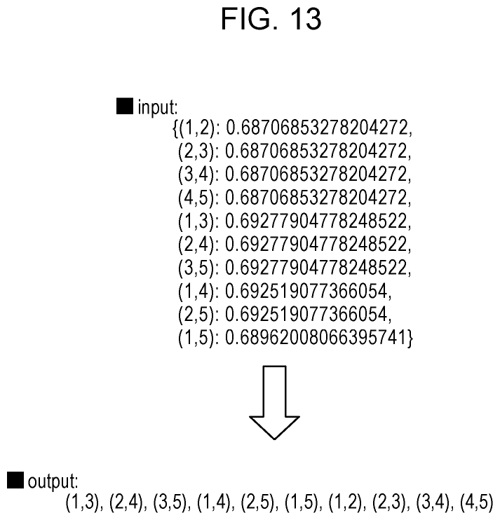

Next, with reference to FIGS. 8 to 13, a specific example is described by using an example in which similarity determination among documents is performed. FIG. 8 illustrates a specific example of data. FIG. 9 illustrates the degrees of duplication of grammatical units among documents as features. FIG. 10 illustrates the content of input data as a learning target and an output result. FIG. 11 illustrates a determination result about determination target data. FIG. 12 illustrates a calculation example of the deviation index. FIG. 13 illustrates a setting example of the priority order used when redetermination is performed. It is noted that, for ease of description, data used for learning and data used for determination are identical to each other in this example, but this is a mere example and the embodiment is not limited to this example.

Firstly, a learner is trained by using the degree of duplication of grammatical units (for example, words) between documents and a learning model for determining whether documents are similar to each other is developed. As illustrated in FIG. 8, units of learning target data in an analogous relationship are tagged together. Specifically, the content of a document 1 is “Ashita Taroto gohanwo tabeni iku”, the content of a document 2 is “Ashita Hanakoto gohanwo tabeni iku”, the content of a document 3 is “Ashita Hanakoto sushiwo tabeni iku”, the content of a document 4 is “Ashita Hanakoto sushiwo nigirini iku”, and the content of a document 5 is “Raigetsu Hanakoto sushiwo nigirini iku”. The documents 1 and 2 are in an analogous relationship, the documents 2 and 3 are in an analogous relationship, the documents 3 and 4 are in an analogous relationship, and the documents 4 and 5 are in an analogous relationship.

The learning circuit 21 calculates the degree of duplication of grammatical units between documents and learns the degree of duplication as a feature. Specifically, concerning the documents 1 and 2, in accordance with the information indicating the document 1 as “ashita; Taroto; gohanwo; tabeni; iku” and the information indicating the document 2 as “ashita; Hanakoto; gohanwo; tabeni; iku”, which are obtained by employing an existing analysis method, such as morphological analysis or a grammatical unit extraction method, the learning circuit 21 specifies that the documents 1 and 2 contain six grammatical units as follows: “ashita; Taroto; gohanwo; tabeni; iku” and “Hanakoto”. Among the six grammatical units, four grammatical units “ashita; gohanwo; tabeni; iku” are common to the documents 1 and 2, and the learning circuit 21 accordingly calculates the degree of duplication as 4/6≈0.667.

Similarly, concerning the documents 1 and 3, in accordance with the information indicating the document 1 as “ashita; Taroto; gohanwo; tabeni; iku” and the information indicating the document 3 as “ashita; Hanakoto; sushiwo; tabeni; iku”, the learning circuit 21 specifies that the documents 1 and 3 contain seven grammatical units as follows: “ashita; Taroto; gohanwo; tabeni; iku” and “Hanako; sushiwo”. Among the seven grammatical units, three grammatical units “ashita; tabeni; iku” are common to the documents 1 and 3, and the learning circuit 21 accordingly calculates the degree of duplication as 3/7≈0.43.

Calculation results of the degrees of duplication among documents calculated as described above are indicated in FIG. 9. As indicated in FIG. 9, the degree of duplication between the documents 1 and 2 in an analogous relationship is 0.67, the degree of duplication between the documents 2 and 3 in an analogous relationship is 0.67, the degree of duplication between the documents 3 and 4 in an analogous relationship is 0.67, and the degree of duplication between the documents 4 and 5 in an analogous relationship is 0.67, and therefore, it is determined that two documents whose degree of duplication is equal to or greater than 0.67 are in an analogous relationship.

Accordingly, the learning circuit 21 labels documents to indicate that particular documents are in an analogous relationship or not in an analogous relationship. The learning circuit 21 performs machine learning by using data of the documents and the labels as input data and carries out learning of similarity determination. For example, as indicated in FIG. 10, {(1,2):0.67, (2,3):0.67, (3,4):0.67, (4,5):0.67, (1,3):0.43, (2,4):0.43, (3,5):0.43, (1,4):0.25, (2,5):0.25, (1,5):0.11} are set as learning data (documents:the similarity degree). In the same order as the learning data indicated above, [1, 1, 1, 1, 1, 0, 0, 0, 0, 0, 0] are set as labels. To be specific, the label 1 is set for the learning data {(1,2):0.67} and the label 0 is set for the learning data {(2,5):0.25}.

By performing machine learning using the learning data and the labels as input data, the learning circuit 21 performs machine learning by using the degrees of duplication among documents as features and obtains weights of the features as learning results. Specifically, the learning circuit 21 obtains the weights w₁ and w₀ as indicated in FIG. 10. A sigmoid function for similarity determination between documents is determined in accordance with the obtained weight w₁ and w₀.

The determination circuit 22 then performs the determination processing in which the value of similarity probability and the value of dissimilarity probability are obtained with respect to documents as determination target data by using the sigmoid function determined in accordance with the weights w₁ and w₀ obtained by learning. The similarity probability indicates how likely two documents are similar to each other and the dissimilarity probability indicates how likely two documents are dissimilar to each other. Specifically, as indicated in FIG. 11, the determination circuit 22 performs the determination processing by using the determination target data (documents:the similarity degree) {(1,2):0.67, (2,3):0.67, (3,4):0.67, (4,5):0.67, (1,3):0.43, (2,4):0.43, (3,5):0.43, (1,4):0.25, (2,5):0.25, (1,5):0.11} as input data.

The determination circuit 22 obtains, for each pair of the documents 1 and 2, the documents 2 and 3, the documents 3 and 4, and the documents 4 and 5, the value of dissimilarity probability 0.44492586 and the value of similarity probability 0.55507414. The determination circuit 22 obtains, for each pair of the documents 1 and 3, the documents 2 and 4, and the documents 3 and 5, the value of dissimilarity probability 0.48643373 and the value of similarity probability 0.51356627. The determination circuit 22 obtains, for each pair of the documents 1 and 4 and the documents 2 and 5, the value of dissimilarity probability 0.51771965 and the value of similarity probability 0.48228035. The determination circuit 22 obtains, for the documents 1 and 5, the value of dissimilarity probability 0.54196994 and the value of similarity probability 0.458030006.

Accordingly, the determination circuit 22 selects a probability higher than the other probability as the determination result. For example, the determination circuit 22 determines that the documents 1 and 2, the documents 2 and 3, the documents 3 and 4, and the documents 4 and 5 are similar to each other in each pair, the documents 1 and 3, the documents 2 and 4, and the documents 3 and 5 are similar to each other in each pair, and the documents 1 and 4, the documents 2 and 5, and the documents 1 and 5 are dissimilar to each other in each pair.

Subsequently, the rank specification circuit 23 inputs the values of probability among documents into equation 1 indicated above as deviation indexes and calculates the average amount of information. Specifically, the rank specification circuit 23 calculates, with respect to all relationships among documents, H(P) by using each value of probability as the individual phenomenon (A) and 2 as the all phenomena (Q). The calculation results of deviation indexes obtained by the rank specification circuit 23 are indicated in FIG. 12. As indicated in FIG. 12, the rank specification circuit 23 obtains, for each pair of the documents 1 and 2, the documents 2 and 3, the documents 3 and 4, and the documents 4 and 5, 0.68706853278204272 as the deviation index (the average amount of information) by calculation. Similarly, the rank specification circuit 23 obtains, for each pair of the documents 1 and 3, the documents 2 and 4, and the documents 3 and 5, 0.69277904778248522 as the deviation index (the average amount of information) by calculation. Similarly, the rank specification circuit 23 obtains, for each pair of the documents 1 and 4 and the documents 2 and 5, 0.692519077366054 as the deviation index (the average amount of information) by calculation. Similarly, the rank specification circuit 23 obtains, for the documents 1 and 5, 0.68962008066395741 as the deviation index (the average amount of information) by calculation.

The rank specification circuit 23 determines ranks by determining that the degree of impact caused by adjusting the learning model increases as the value of the deviation index increases. Specifically, as indicated in FIG. 13, the rank specification circuit 23 orders the deviation indexes of documents in descending order and determines the priority order as follows: the documents 1 and 3, the documents 2 and 4, the documents 3 and 5, the documents 1 and 4, the documents 2 and 5, the documents 1 and 5, the documents 1 and 2, the documents 2 and 3, the documents 3 and 4, and the documents 4 and 5.

As a result, in the case after the first learning processing, the similarity determination is performed in the descending order of the degree of duplication as follows: the documents 1 and 2, the documents 2 and 3, the documents 3 and 4, the documents 4 and 5, the documents 1 and 3, the documents 2 and 4, the documents 3 and 5, the documents 1 and 4, the documents 2 and 5, and the documents 1 and 5. However, in the case after the learning model is updated, the similarity determination is performed in order starting with a document pair about which the determination result is most likely changed, that is, the order is as follows: the documents 1 and 3, the documents 2 and 4, the documents 3 and 5, the documents 1 and 4, the documents 2 and 5, the documents 1 and 5, the documents 1 and 2, the documents 2 and 3, the documents 3 and 4, and the documents 4 and 5.

Effectiveness

The prioritization in accordance with the degree of uncertainty (the deviation index) is effective when the change in the learning model between before and after adjustment of the learning model is very small. The very small change in the learning model denotes the very small change in parameters in the learning model; in other words, the very small change in the learning model denotes a learning model in which, when the learning model before adjustment corresponds to f(x; w_{old}) and the learning model after adjustment corresponds to f(x; w_{new}), the value of w_{new}−w_{old} is very small.

When the determination result is certain as illustrated on both sides of the graph in FIG. 6, the determination result is unlikely changed between before and after adjustment of the learning model. Conversely, the determination result in the area in which the determination result is uncertain as the center area of the graph in FIG. 5 is likely changed due to a very small change, false positive or false negative is likely found in the learning model before adjustment. Therefore, it is possible to increase the speed of performing the entire processing by performing again the determination processing while giving priority to the determination results in the area in which determination results are likely changed due to adjustment of the learning model.

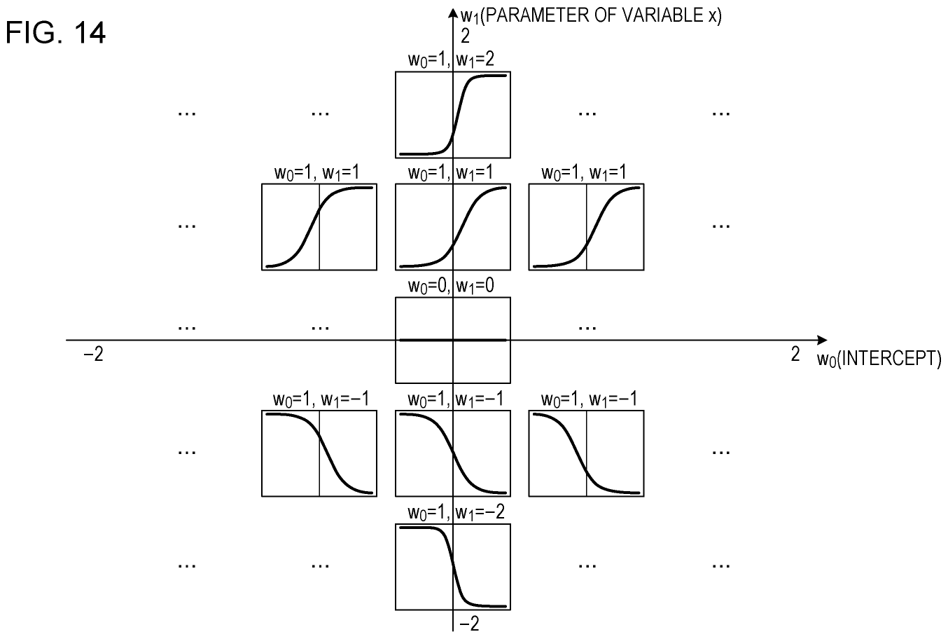

FIG. 14 illustrates relationships between the changes in parameters and the determination function. As illustrated in FIG. 14, in the graphs adjacent to each other in the area of the weights w₁>1, w₁=0, and w₀<0, the change in the center area of each graph is relatively large whereas the changes in the both side areas are relatively small, and thus, it is considered that the change in parameters is very small. In such areas, the ranking processing for determination target data in accordance with the first embodiment is effective. By contrast, when the change beyond w₁=0 occurs, the graphs are considerably changed, and thus, it is considered that the significantly large degree of adjustment in parameters occurs. In this case, it is desired to perform redetermination for all units of determination target data instead of performing the ranking processing in accordance with the first embodiment.

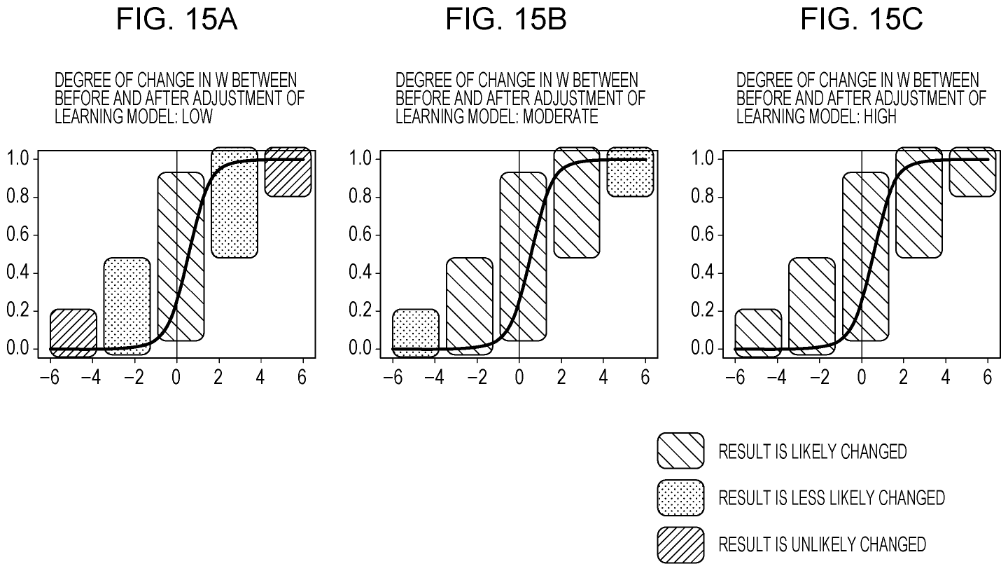

FIGS. 15A to 15C illustrate relationships between the degree of adjustment of the learning model and the change in the determination result. As illustrated in FIG. 15A, when the degree of change in the parameter (the weight) w between before and after adjustment of the learning model is relatively low, the determination results in the center area are likely changed. As illustrated in FIG. 15C, when the degree of change in the parameter (the weight) w between before and after adjustment of the learning model is relatively high, the determination results in all areas of the graph are likely changed. As illustrated in FIG. 15B, when the degree of change in the parameter (weight) w between before and after adjustment of the learning model is between the degree in FIG. 15A and the degree in FIG. 15C, the determination results in areas other than both sides of the graph are likely changed. The horizontal axis in FIG. 15 indicates the input x described above and the vertical axis indicates f(x), that is, the deviation index.

The learning apparatus 10 is thus able to control the redetermination processing by determining the range of the deviation index used for selecting determination targets in accordance with the degree of change in parameters between before and after adjustment of the learning model. For example, when the degree of change in parameters between before and after adjustment of the learning model is less than a first threshold, the learning apparatus 10 determines the range of the deviation index in which x falls within the range of −1 to 1 as the redetermination target range. When the degree of change in parameters between before and after adjustment of the learning model is equal to or greater than the first threshold and less than a second threshold, the learning apparatus 10 determines the range of the deviation index in which x falls within the range of −3 to 3 as the redetermination target range. When the degree of change in parameters between before and after adjustment of the learning model is equal to or greater than the second threshold, the learning apparatus 10 determines the entire range of the deviation index as the redetermination target range.

In another example, the learning apparatus 10 may calculate the degree of change in parameters between before and after adjustment of the learning model; and order units of determination target data when the degree of change is less than a threshold, or determine all units of determination target data as targets for the redetermination processing when the degree of change is equal to or greater than the threshold. In still another example, when the degree of change in parameters between before and after adjustment of the learning model is less than the first threshold, the learning apparatus 10 ranks all units of determination target data and determines particular units of determination target data ranked among the top 50 as redetermination target data; when the degree of change is equal to or greater than the first threshold and less than the second threshold, the learning apparatus 10 ranks all units of determination target data and determines particular units of determination target data ranked among the top 100 as redetermination target data; when the degree of change is equal to or greater than the second threshold, the learning apparatus 10 determines all units of determination target data as redetermination target data.

It is noted that, in actual learning models, since the number of parameters is very large, the change beyond 0 in the majority of parameters with respect to the total number of parameters rarely occurs due to only a single adjustment, and thus, the ranking processing for determination target data in accordance with the first embodiment is significantly effective.

### Advantages

As described above, when the learning model is updated, the learning apparatus 10 accordingly performs the redetermination processing while giving priority successively to a particular unit of determination target data about which the determination result is most likely changed among the determination results obtained in accordance with the learning model before adjustment, and therefore, it is possible to speedily obtain determination results. As a result, redetermination may be performed for only determination target data whose impact is relatively large, and thus, it is possible to reduce the time taken for the redetermination processing after adjustment of the learning model.

As the degree of change between before and after adjustment of the learning model increases, the situation approaches the case in which determination targets are randomly selected and the difference in cost between the case of using the priority order and the case of random selection is small. However, in the operation in which the frequency of structural change in the learning model is lower than the frequency of adjustment of the learning model, the method according to the first embodiment is advantageous. The frequency of adjustment of the learning model is the frequency of recreating the learning model as desired through daily use of the learning model and is, for example, a regular frequency (for example, once a month). The structural change in the learning model is caused by events that fundamentally alter the determination method.

### Second Embodiment

The learning apparatus 10 may narrow determination target data down to data targeted for the redetermination processing. Specifically, the learning apparatus 10 not only determines the priority order but also designates a particular rank to end the determination processing. In a second embodiment, a setting example of an end condition of the redetermination processing is described.

Specifically, the learning apparatus 10 performs estimation by carrying out another learning operation to learn the sum of the degrees of change in the weight w=(w₀, w₁, . . . , wₙ) as a variable and the ranks in which changes occurred between before and after adjustment of the learning model in accordance with previous cases. For example, the learning apparatus 10 performs projection in accordance with relative ranks in which the determination result was not changed between before and after adjustment of the learning model and the sums of weights of previous cases.

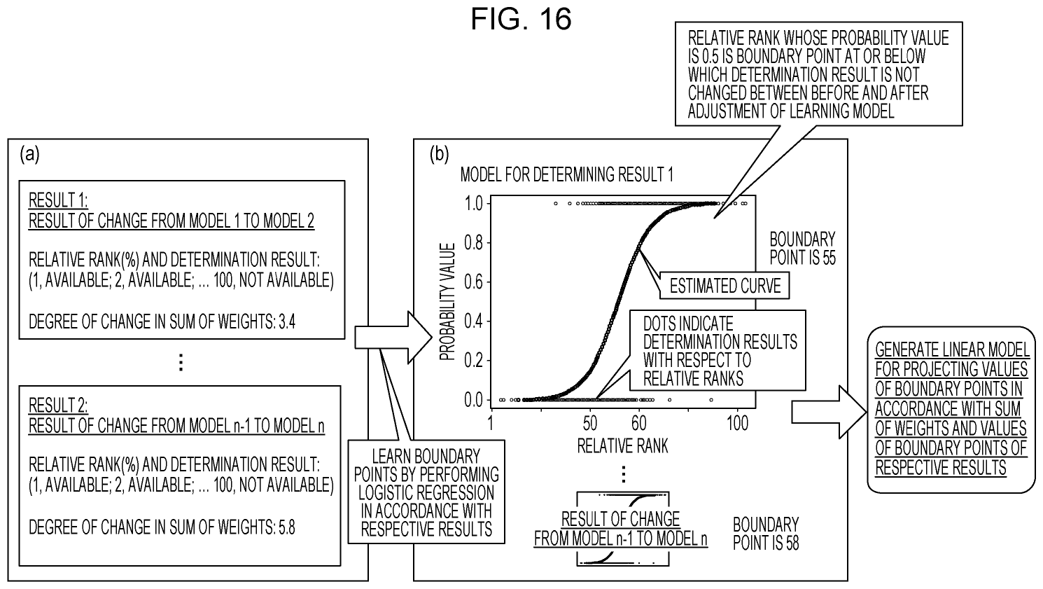

FIG. 16 illustrates a setting example of an end condition. As illustrated in FIG. 16(a), the rank specification circuit 23 extracts, with respect to each time of adjustment of the learning model, information of the relative rank, which indicates a determination rank used when redetermination was performed, the presence or absence of the determination result, which indicates whether the determination result was changed between before and after adjustment, and the degree of change in the sum of weights, which specifies how much the learning model was updated. By performing logistic regression in accordance with the extraction results, the rank specification circuit 23 learns a boundary point at or below which the result of determination processing is not changed due to adjustment of the learning model. For example, the rank specification circuit 23 calculates the relative ranks, the presence or absence of the determination result, and the degree of change in the sum of weights (3.4) in regard to the case of adjustment from a learning model 1 to a learning model 2 (result 1) and learns the boundary point by performing logistic regression by using the calculated set of information. Similarly, the rank specification circuit 23 learns the boundary point in regard to the case of adjustment from the learning model 2 to a learning model 3 (result 2).

Subsequently, as illustrated in FIG. 16(b), the rank specification circuit 23 generates, in accordance with the relative ranks and probability values, a learning model for specifying the boundary point, and also generates, in accordance with the sum of weights and the value of the boundary point of each learned result, a linear model for projecting the value of the boundary point. For example, concerning the result 1, the relative rank (rank 55) whose probability value is 0.5 is specified as the boundary point at or below which the determination result is not changed between before and after adjustment of the learning model and the information of the degree of change in the sum of weights (3.4) and the information of the relative rank (rank 55) are extracted. In this manner, the rank specification circuit 23 extracts, with respect to each result, information of the degree of change in the sum of weights and information of the relative rank, learns the correspondence between them, and accordingly generates a linear model for projecting the value of the boundary point.

The rank specification circuit 23 calculates the degree of change in the sum of weights between before and after adjustment of the learning model (p) after the learning model is newly updated. The rank specification circuit 23 then calculates a rank (rank h), which is the value of the boundary point, in accordance with the degree of change by using the linear model for projecting the value of the boundary point. As a result, the rank specification circuit 23 determines, as redetermination processing targets, particular units of data corresponding to a rank (rank 1) to a rank (rank h) in the priority order calculated in the first embodiment. Other than the method describe above, another method may be applied in which the highest rank, the lowest rank, or the average rank of the ranks specified as boundary points (see FIG. 16(b)) with respect to respective results is used as the end condition.

As described above, the learning apparatus 10 narrows determination data down to only data about which the determination result is likely changed and determines the data as the redetermination target data used after the learning model is updated, and thus, the learning apparatus 10 is able to speedily perform determination for only the data about which the determination result is possibly changed. As a result, the learning apparatus 10 is able to reduce the time taken to perform the redetermination processing after adjustment of the learning model, resulting in reducing the risk of serious opportunity loss.

### Third Embodiment

The embodiments of the present disclosure have been described above, but the present disclosure may be implemented as various other embodiments other than the embodiments described above.

Learning Data

The example of supervised learning, in which supervised data is used as learning data, is used in the description of the first embodiment, but the learning method is not limited to this example and, for example, unsupervised learning using unsupervised data or semi-supervised learning using both supervised data and unsupervised data may also be applied. The example of learning analogous relationships among documents is used in the description of the first embodiment, but the target of learning is not limited to this example and the present disclosure may be applied to various general targets for learning.

Selection in Accordance with Standard

The learning apparatus 10 may select a particular unit of determination target data targeted for redetermination from plurality of pieces of determination target data in accordance with a predetermined standard of the deviation index. For example, the learning apparatus 10 determines a threshold of the deviation index indicating that the determination result is highly likely changed in accordance with past cases and selects as determination target data a particular unit of data corresponding to a deviation index equal to or greater than the threshold. The threshold may specify a range targeted for determination in accordance with past cases.

Time of Adjusting Learning Model and Ranking

For example, after a learning model A is updated to a learning model B, the learning apparatus 10 determines a priority order of units of determination target data by using parameters of the learning model B and performs redetermination in the priority order. While the redetermination processing is performed, the learning model B may be updated to a learning model C. In this case, the learning apparatus 10 may end the current redetermination processing, determine another priority order of the units of determination target data by using parameters of the learning model C, and perform redetermination in the other priority order. Alternatively, the learning apparatus 10 may continue the current redetermination processing and determine another priority order of the units of determination target data by using parameters of the learning model C in parallel with the current redetermination processing. The learning apparatus 10 may then perform redetermination in the other priority order after the current redetermination processing is completed.

Learning: Neural Network

In this embodiment, in addition to general machine learning technologies, various neural networks, such as the RNN and a convolutional neural network (CNN), may be employed. Furthermore, in terms of learning methods, various methods may be applied in addition to the backpropagation. A neural network has a multi-layer structure composed of, for example, an input layer, an intermediate layer (a hidden layer), and an output layer, and multiple nodes are connected by edges across these layers. Each layer has a function referred to as an activation function, each edge has a weight, and the value of each node is calculated in accordance with the value of a node in a preceding layer, the value of the weight of a connecting edge (the weight coefficient), and the activation function of the layer. Various known methods may be applied as the calculation method.

Learning in a neural network is modifying parameter, that is, weights and biases, so as to cause the output layer to output a correct value. In the backpropagation, a loss function, which indicates how much the output value of the output layer deviates from a correct value (a desired value), is determined for the neural network and weights and biases are updated so as to minimize the loss function by using, for example, gradient descent.

System

The processing procedure, the control procedure, the specific names, and the information including various kinds of data and parameters indicated in the above description and the drawings may be changed as desired unless otherwise stated. Furthermore, the specific examples, the distributions, the numerical values, and the like described in the embodiments are mere examples and may be modified as desired.

Moreover, the constituent elements of the apparatuses illustrated in the drawings are of functional concepts and not necessarily configured physically as illustrated in the drawings. In other words, the specific configurations of distribution or combination of the apparatuses are not limited to the configurations illustrated in the drawings. All or some of the apparatuses may be functionally or physically distributed or combined in desired units depending on various loads or usage conditions. Further, the processing functions performed by the apparatuses may be entirely or partially implemented by using a CPU and a program analyzed and run by the CPU or implemented as hardware devices using a wired logic connection.

Hardware

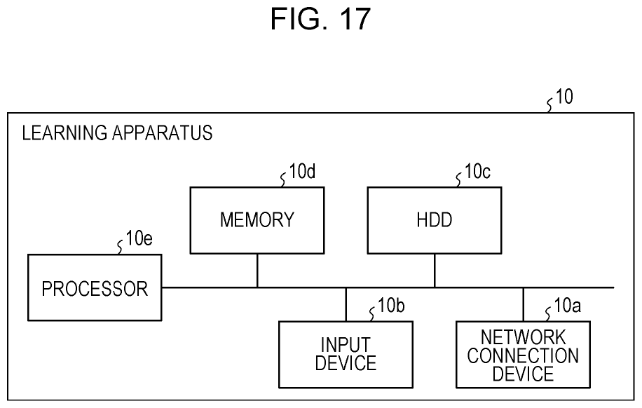

FIG. 17 illustrates an example of a hardware configuration of the learning apparatus 10. As illustrated in FIG. 17, the learning apparatus 10 includes a network connection device 10a, an input device 10b, a hard disk drive (HDD) 10c, a memory 10d, and a processor 10e. The components illustrated in FIG. 17 are coupled via, for example, a bus.

The network connection device 10a is, for example, a network interface card and used for communicating with a server. The input device 10b is, for example, a mouse and a keyboard and receives various instructions and the like from users. The HDD 10c stores a program and DBs that implement the functions illustrated in FIG. 2.

The processor 10e reads from the HDD 10c or the like a program for performing processing operations corresponding to the processing circuits illustrated in FIG. 2 and loads the program into the memory 10d, such that processes for implementing the functions illustrated in, for example, FIG. 2 are executed. These processes implement functions corresponding to the processing circuits included in the learning apparatus 10. Specifically, the processor 10e reads from the HDD 10c or the like a program including the functions corresponding to the learning circuit 21, the determination circuit 22, the rank specification circuit 23, and the like. The processor 10e executes the processes that perform the processing operations corresponding to the learning circuit 21, the determination circuit 22, the rank specification circuit 23, and the like.

As described above, the learning apparatus 10 operates as an information processing apparatus that performs processing of a learning method by running a program that is read. The learning apparatus 10 may also implement the same functions as described in the above embodiments by reading the program from a storage medium by using a medium reading device and running the program that is read. It is noted that the program mentioned in the other embodiments is not limited to a program that is run in the learning apparatus 10. For example, the present disclosure may be applied to the case in which the program is run in another computer, a server, or both in conjunction with each other.

The program may be distributed via a network, such as the Internet. Alternatively, the program may be stored in a computer-readable storage medium, such as a hard disk, a flexible disk (FD), a CD-ROM, a magneto-optical disk (MO), or a digital versatile disc (DVD), read from the computer-readable storage medium, and run by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A selection method executed by a processor included in a selection apparatus, the selection method comprising:
when a plurality of pieces of data are each determined as one of a plurality of determination candidates by using a learning model, calculating, for each of the plurality of pieces of data, a deviation index indicating a degree of uncertainty of a determination result obtained by using the learning model with respect to each of the plurality of determination candidates; and
when the learning model is updated, selecting a particular piece of data targeted for redetermination to be performed by using the updated learning model from the plurality of pieces of data in accordance with the deviation index.

2. The selection method according to claim 1,
wherein the selecting includes ranking the plurality of pieces of data in a priority order in accordance with the deviation index of the determination result relating to each of the plurality of pieces of data and selecting a particular unit of data targeted for redetermination to be performed by using the updated learning model from the plurality of pieces of data in accordance with the priority order.

3. The selection method according to claim 1,
wherein the selecting includes selecting a particular unit of data targeted for redetermination to be performed by using the updated learning model from the plurality of pieces of data in accordance with a predetermined standard of the deviation index.

4. The selection method according to claim 1,
wherein the selecting includes determining, by using a degree of adjustment change in the learning model between before and after adjustment, a range of the deviation index in accordance with which a particular unit of data targeted for redetermination to be performed by using the updated learning model is selected from the plurality of pieces of data.

5. A selection apparatus comprising:
a memory; and
a processor coupled to the memory and configured to:
when plurality of pieces of data are each determined as one of multiple determination candidates by using a learning model, calculate, for each of the plurality of pieces of data, a deviation index indicating a degree of uncertainty of a determination result obtained by using the learning model with respect to each of the multiple determination candidates, and
when the learning model is updated, responsively select a particular unit of data targeted for redetermination to be performed by using the updated learning model from the plurality of pieces of data in accordance with the deviation index.

6. A non-transitory computer-readable recording medium storing a program that causes a processor included in a selection apparatus to execute a process, the process comprising:
when plurality of pieces of data are each determined as one of multiple determination candidates by using a learning model, calculating, for each of the plurality of pieces of data, a deviation index indicating a degree of uncertainty of a determination result obtained by using the learning model with respect to each of the multiple determination candidates; and
when the learning model is updated, responsively selecting a particular unit of data targeted for redetermination to be performed by using the updated learning model from the plurality of pieces of data in accordance with the deviation index.
